(19) United States
(12) Patent Application Publication
(10) Pub. No.: US 2011/0217580 A1
(43) Pub. Date: Sep. 8, 2011

(54) SANITARY DISPENSER

(76) Inventor: Hans Georg Hagleitner, Zell am See (AT)

(21) Appl. No.: 12/717,491

(22) Filed: Mar. 4, 2010

(51) Int. Cl. H01M 2/10

(52) U.S. Cl. 429/99; 429/100

(57) ABSTRACT

A battery-powered sanitary dispenser has a housing and a battery holder for batteries. The battery holder can be pulled out of the housing at the front, like a drawer.

### BACKGROUND OF THE INVENTION

### Field of the Invention

The invention relates to a battery-powered sanitary dispenser having a housing and having a battery holder which can be removed from the housing.

Recently, for hygiene reasons, dispensers which can be operated in a contactless manner have been increasingly developed for paper towels, toilet paper, soap, soap foam, etc. They are operated by batteries in all those locations in which there is no electrical power connection, or else where such a mains connection is not desirable. The batteries are inserted into a battery holder, which in some cases is accessible only with difficulty.

A certain amount of simplification is achieved by providing a holder for the batteries, which holder can be filled outside the dispenser and can be inserted into the appliance with the batteries. By way of example, U.S. Pat. No. 6,698,616 B2 describes a liquid dispenser with a holder of the type that can be inserted vertically on the upper face of a dispenser. The upper face may be difficult to access by relatively short persons in some circumstances, in particular if the battery holder is arranged somewhat recessed behind a further part of the dispenser housing.

Furthermore, U.S. Pat. No. 6,793,105 B1 describes a soap dispenser with a battery holder that is inserted between a soap supply container and a pump. In that case as well, access to the batteries is difficult, since the soap supply container and a cover must be removed before the batteries are accessible. The batteries can then be removed individually or can be raised upward with the holder, since the connecting tube between the soap supply container and the pump runs through the battery holder.

### SUMMARY OF THE INVENTION

It is accordingly an object of the invention to provide a sanitary dispenser which overcome the above-mentioned disadvantages of the heretofore-known devices and methods of this general type and which allows for simple battery replacement even by relatively short people and which renders same simpler in general.

With the foregoing and other objects in view there is provided, in accordance with the invention, a battery-powered sanitary dispenser, comprising:

a housing enclosing the functional parts of the sanitary dispenser;

a battery holder removably mounted in the housing, the battery holder being in the form of a drawer that can be pulled horizontally out of the housing.

In other words, the objects of the invention are achieved in that the battery holder is in the form of a drawer which can be pulled horizontally out of the housing. In this case, one preferred embodiment provides that the battery holder is accessible within a housing cover which can be opened. Once the dispenser that is mounted on the wall has been opened, it is therefore easily and quickly possible to pull the battery holder out from its operating or working position, in which the electrical connection exists and the batteries contained are secured in their position, at the front, and to remove them. The batteries can now be replaced, and the battery holder can be reinserted into the housing.

In accordance with a preferred embodiment, the battery holder can be pulled out at the front of the housing. According to an exemplary embodiment, the housing includes a cover that can be opened, and the battery holder is accessible behind the cover. The cover may be pivotally mounted in a pivoting guide about a horizontal axis in an upper region of the housing.

In accordance with another feature of the invention, the housing is formed with an insert compartment and a drawer guide in the insert compartment, and the insert compartment is formed to receive the battery holder. Preferably, the battery drawer includes two holders, disposed one above another, for batteries. In a preferred embodiment, the battery holder includes a side wall formed with open cutouts for a positive pole of a battery and for a negative pole of a second battery, and wherein corresponding electrical contacts are disposed on one side of the insert compartment in the housing. It is further advantageous to provide an inwardly projecting projection disposed on the side wall of the battery holder that is associated with the positive pole of at least one battery.

In accordance with a concomitant feature of the invention, there are latching elements disposed on the battery holder and on the drawer guide of the housing.

The battery holder preferably contains substantially cylindrical batteries, either non-rechargeable disposable batteries or rechargeable batteries, in particular in two rows of two each, wherein a positive pole and a negative pole are exposed in the side wall of the battery holder, and the electrical connecting contacts are provided on the same side in the dispenser. In one preferred embodiment, a projection which projects inward is provided on the battery holder in the area alongside the button-like positive pole of at least one battery, in such a way that, if a battery is inserted incorrectly, no electrical connection is made with the connecting contact, since the battery rests on the projection and a gap remains between the negative pole and the connecting contact. In order to secure the operating or working position, latching elements which interact with one another and detachably fix the inserted position of the battery holder can be provided on the housing and on the battery holder.

Other features which are considered as characteristic for the invention are set forth in the appended claims.

Although the invention is illustrated and described herein as embodied in a sanitary dispenser, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a perspective view of a dispenser according to the invention with an open cover;

FIG. 2 is a perspective view of a detail of the dispenser with the battery drawer pulled out;

FIG. 3 is an enlarged sectional view of a battery inserted into the battery drawer; and

FIG. 4 is a similar view of the detail, illustrating the battery incorrectly inserted.

### DETAILED DESCRIPTION OF THE INVENTION

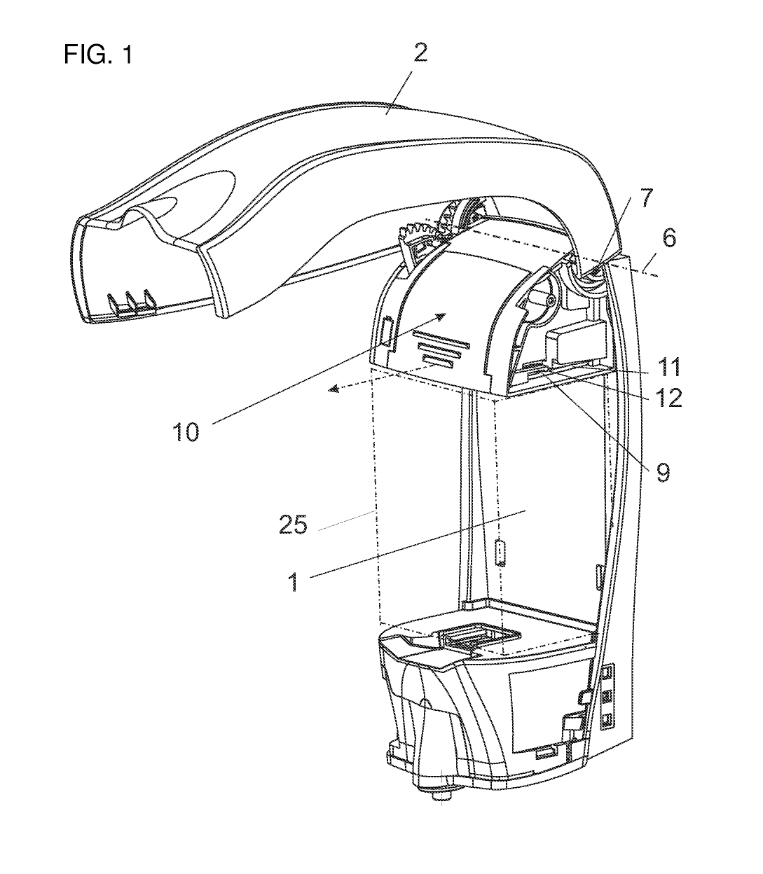

Referring now to the figures of the drawing in detail and first, particularly, to FIG. 1 thereof, there is shown a sanitary dispenser that is intended, in particular, to hold a container 25 with liquid or creamy contents, such as soap, disinfectant or the like. The content is emitted in portions, in a manner which will not be described in any more detail here, by means of a battery-powered metering apparatus which is arranged in the lower region of the housing 1. The dispenser is preferably operated contactlessly and it will typically be mounted on a wall.

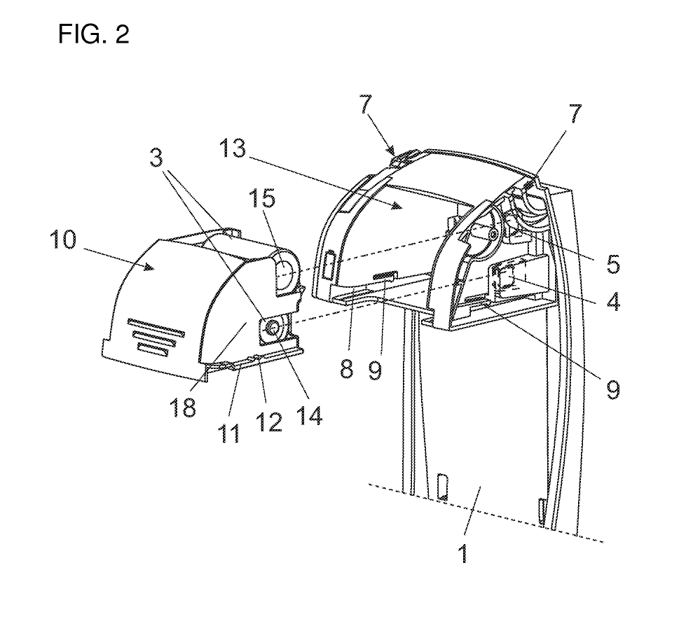

The housing 1 of the dispenser is provided with a cover 2 that covers the functional parts of the sanitary dispenser. The cover 2 can be pivoted up about an upper horizontal axis 6 in a side pivoting guide 7, as is shown in FIG. 1. The dispenser uses conventional cylindrical batteries 3 as an electrical power source, with a projecting knob forming a positive pole 14 and a flat rear face forming a negative pole 15. The batteries can be inserted into a drawer-like battery holder 10, as illustrated in FIG. 2, and can be removed horizontally at the front from the dispenser, which is mounted on a wall or the like. The at least two, and preferably four, batteries 3 are inserted such that a positive pole 14 and a negative pole 15 are exposed one above the other on the same side of the battery holder 10, in cutouts in the side wall 18. The battery holder 10 has webs 11 which project at the side, and on each of which a latching element 12 is formed.

In the area of the pivoting guide 7, the housing 1 has an insert compartment 13, which is provided with side grooves 8 forming a drawer guide in which the webs 11 of the battery holder engage. A sprung or springy tongue 9 is provided in the upper side wall of each groove 8 and latches with the latching elements 12 of the inserted battery holder 10.

Electrical connecting contacts 4, 5 for both battery poles 14, 15 are provided in the form of sprung metal lugs on the same side of the housing 1, thus making an electrical connection when the battery holder 10 is inserted. The batteries 3 cannot be accessed in the battery holder 10 when the cover 2 is closed and locked. As illustrated in FIG. 2, after authorized opening of the cover, the battery holder 10 can be pulled out at the front, in order to replace the batteries 3 or to remove them when the dispenser is not being used for a relatively long time. Depending on the conditions for the wall mounting of the dispenser, the battery holder 10 is at a height of about 100 to 140 cm above the floor (approx. 3.3 to 4.6 ft.), which represents a working height which is still advantageous, even for relatively short persons.

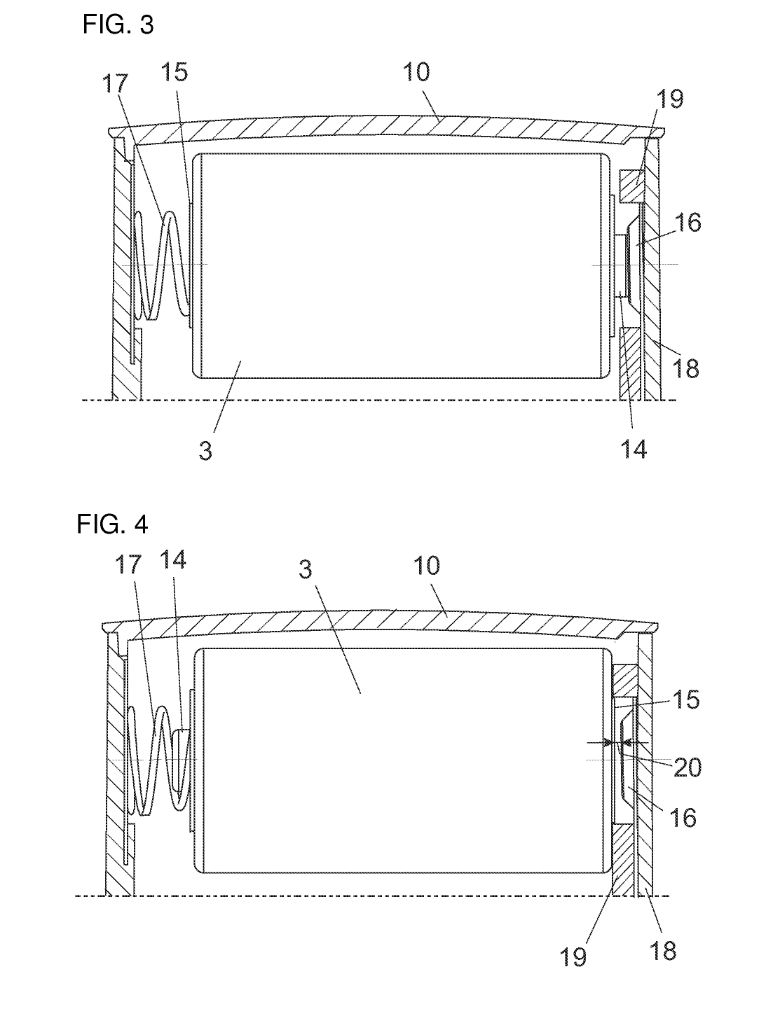

With reference to FIGS. 3 and 4, a contact lug 16 is associated in the normal manner with the positive battery pole 14 on one side wall 18 of the battery holder 10, and a contact spring 17 is associated with the negative battery pole 15 on the opposite side wall. FIG. 3 shows the battery 3 in the correct position, that is to say the positive pole 14 is making contact with the contact lug 16 and the spring 17 is pressing on the negative pole 15. A projection 19 that is fitted to the side wall 18 has no function. In contrast, if, as is shown in FIG. 4, the battery 3 is inserted incorrectly, then it is pressed against the projection 19 by the spring, without any electrical contact being made, since a gap 20 remains and the flat negative pole 15 cannot touch the contact lug 16.

1. A battery-powered sanitary dispenser, comprising:
a housing enclosing functional parts of a sanitary dispenser;
a battery holder removably mounted in said housing, said battery holder being in the form of a drawer that can be pulled horizontally out of said housing.

2. The sanitary dispenser according to claim 1, wherein said housing has a front and said battery holder can be pulled out at said front.

3. The sanitary dispenser according to claim 1, wherein said housing includes a cover that can be opened, and said battery holder is accessible behind said cover.

4. The sanitary dispenser according to claim 3, wherein said cover is pivotally mounted in a pivoting guide about a horizontal axis in an upper region of said housing.

5. The sanitary dispenser according to claim 1, wherein said housing is formed with an insert compartment and a drawer guide in said insert compartment, and said insert compartment is formed to receive said battery holder.

6. The sanitary dispenser according to claim 5, wherein said battery holder includes two holders, disposed one above another, for batteries.

7. The sanitary dispenser according to claim 6, wherein said battery holder includes a side wall formed with open cutouts for a positive pole of a battery and for a negative pole of a second battery, and wherein corresponding electrical contacts are disposed on one side of said insert compartment in said housing.

8. The sanitary dispenser according to claim 7, which comprises an inwardly projecting projection disposed on the side wall of said battery holder that is associated with the positive pole of at least one battery.

9. The sanitary dispenser according to claim 5, which comprises latching elements disposed on said battery holder and on said drawer guide of said housing.
